(19) United States
(12) Patent Application Publication
(10) Pub. No.: US 2018/0075729 A1
(43) Pub. Date: Mar. 15, 2018

(54) Tether System

(71) Applicant: Steven W. Hall, Cape Coral, FL (US)

(72) Inventor: Steven W. Hall, Cape Coral, FL (US)

(21) Appl. No.: 15/345,907

(22) Filed: Nov. 8, 2016

Related U.S. Application Data
(60) Provisional application No. 62/385,328, filed on Sep. 9, 2016.

(51) Int. Cl. G08B 21/24; H04W 4/00; H04W 4/02; G08B 25/10

(52) U.S. Cl. CPC G08B 21/24; H04W 4/008; G08B 25/10; H04W 4/021; H04W 4/025

(57) ABSTRACT

A system for tracking a personal possession or item tagged with an electronic device using a portable electronic device. The electronic device is wirelessly connected to the portable device via Bluetooth and together these two form a geofence. An alarm is activated in the electronic device and a wireless signal is sent by the GPS signal transmitter to the GPS signal receiver activated by the mobile application running on the portable electronic device as soon as the personal possession moves out of the geofence. The alarm notifies the position and the wireless signal provides the location of the lost or left personal possession or item.

This application claims priority to U.S. Provisional Patent Application No. 62/385,328 filed on Sep. 9, 2016, which is incorporated herein in its entirety by reference.

### FIELD OF THE DISCLOSURE

The present disclosure relates to the field of wireless system for monitoring and finding lost personal possessions.

### BACKGROUND OF THE DISCLOSURE

The loss of an item, whether through theft or forgetfulness, is something that most people deal with at least once. For unimportant or inexpensive items, this loss can usually be absorbed easily by replacing the item. However, for expensive or important items, the loss may be more difficult to recover from. Moreover, in cases where the lost item is an electronic device that stores data, the loss can be particularly damaging because of not only the loss of the device, but the loss of the stored data, which may have importance for a person's job or for a person's identity or finances.

A number of different types of systems for locating lost or left personal items or possessions are available in the prior art.

U.S. Pat. No. 7,002,473 discloses a system where the articles are tagged with, or contain, an identifying device such as an RFID tag or a wireless network interface, and these identifying devices are monitored regularly, and when the identifying device is out of range, an alarm is raised.

U.S. Pat. No. 7,664,463 discloses a loss prevention system containing a Bluetooth transceiver and a motion detection system which monitors the presence of a portable electronic device in the vicinity and alerts when that device leaves its vicinity.

US patent application Ser. No. 13/412,052 discloses a method that determines a distance for monitoring a transmission signal of an electronic label to be identified by a monitoring device, and calibrates a transmission strength for communication with the electronic label via the transmission signal, monitoring of the communication, and if there is loss of connection raising alarm for the same.

U.S. Pat. No. 8,593,257 discloses RFID systems employed for loss prevention, where an ownership code is written onto an item an item, and further a digital signature is written on to it, and at point-of-exit an exit reader determines if the tagged item is allowed to leave the facility by verifying the ownership code and the digital signature, and an alarm is raised in case of mis-match.

U.S. Pat. No. 8,836,507 uses Hall type magnetic sensors between the items attached to the remote unit and a host unit, and raises an alarm when the item attached to the remote unit, is separated from the host unit.

U.S. Pat. Nos. 8,680,999 and 8,981,934 discloses a loss prevention system comprises a protected article and a receiver. The protected article comprises a transmitter that emits an infrared signal having a carrier frequency that is modulated to encode a digital signature. The receiver detects infrared signals and performs an alarm action if the receiver does not detect within a rolling time window an infrared signal having the carrier frequency that is modulated to encode the digital.

Consequently, there is a need for preventing the loss of a person's personal items or possessions. The system of the current disclosure includes all the advantages of the prior arts and overcomes the disadvantages.

### (F) SUMMARY OF THE DISCLOSURE

In the view of the foregoing disadvantages inherent in the known types of system for locating lost items now present in the prior art, the present disclosure provides an improved system for locating personal possessions. As such, the general purpose of the present disclosure, which will be described subsequently in greater detail, is to provide a new and improved system for monitoring and tracking personal items or possessions which has all the advantages of the prior art and none of the disadvantages.

The system to prevent loss of items of personal use includes a portable electronic device and a first electronic device. The portable device includes a processor, a computer implemented means running on said processor, and a GPS receiver. The computer implemented means automatically activates a short range radio frequency based connectivity based on a user input for tracking of the first electronic device. Through this short range radio frequency connectivity, the portable electronic device and the first electronic device can search each other. The first electronic device comprises an alarm system and a GPS signal transmitter. The GPS signal transmitter transmits a GPS signal when the first electronic device moves out of a geofence. The GPS signal is received by the portable electronic device using the GPS signal receiver to determine the location of the personal item. The alarm system is also activated once the first electronic device when the portable electronic device move out of a geofence.

The alarm raised by the alarm system includes flashing a plurality of lights or a vibrating mechanism with an audible tone to notify the user of the tracking electronic device of the location of the personal possession.

The short range radio frequency based connectivity can be Bluetooth LE tethering technology and the electronic device can be a smartphone or a tablet.

The first electronic device is designed to operably adapt to the periphery of items of personal use. The items of personal use can be key chain, button, clip, wristband, watch, briefcase or like.

In one embodiment, the user input for activating radio frequency means is provided through a user access to a mobile application running on the processor of the portable electronic device.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of other embodiments and of being practiced and carried out in various ways. Also, it is to be understood that the phraseology and terminology employed herein are for the purpose of description and should not be regarded as limiting.

These together with other objects of the disclosure, along with the various features of novelty which characterize the disclosure, are pointed out with particularity in the disclosure. For a better understanding of the disclosure, its operating advantages and the specific objects attained by its uses, reference should be had to the accompanying drawings and descriptive matter in which there are illustrated preferred embodiments of the disclosure.

### (G) BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1A illustrates a portable electronic device and FIG. 1B illustrates a first electronic device, wherein FIG. 1A and FIG. 1B together illustrates a system of a portable electronic device and a first electronic device which helps in prevention of loss of items of personal use.

### (H) DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that the embodiments may be combined, or that other embodiments may be utilized and that structural, electrical and logical changes may be made without departing from the spirit and scope of the present disclosure. The following detailed description is, therefore, not to be taken in a limiting sense, and the scope of the present disclosure is defined by the appended claims and their equivalents.

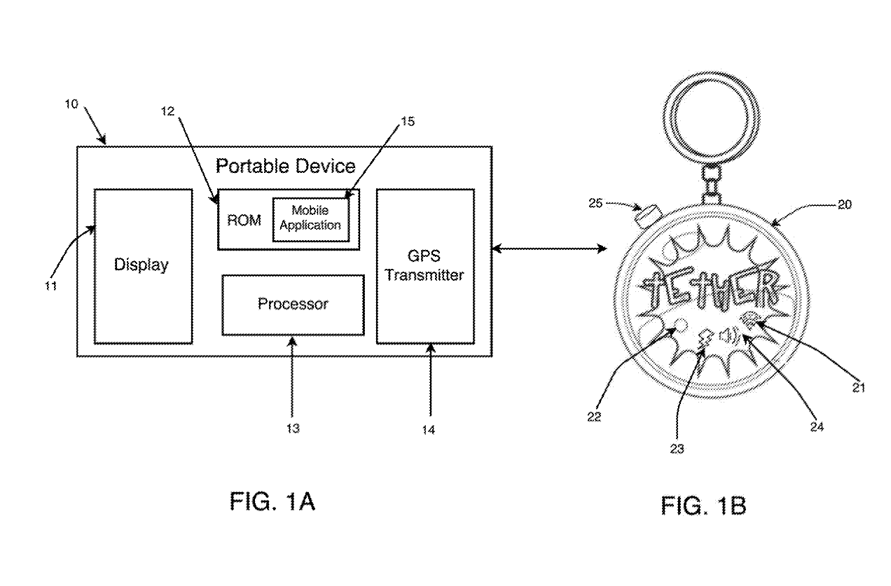

The present disclosure, as described in FIG. 1 A and FIG. 1B, generally provides a system for preventing the loss of personal possessions or items using a Bluetooth and GPS technology. The system utilizes communicably pairing of two electronic devices, i.e., a portable device 10 and an electronic device 20 that are enabled with both the technologies. The Bluetooth LE tethering technology is used for pairing the portable electronic device 10 with the first electronic device 20 that is part of a key ring and includes a GPS signal transmitter 21. The portable electronic device 10 can be a smartphone or a tablet or any other PDA. The portable electronic device 10 further includes a display 11, a read-only memory (ROM) 12, a processor 13 and a GPS signal receiver 14. The portable electronic device 10 has installed a mobile application 15 running on its processor 13. This mobile application 15 is used by a user to automatically activate the Bluetooth tethering and the GPS signal receiver. Alternatively, a mobile application 15 is not required to activate the communication pairing, rather any simple user input interface like a press button can be used to activate Bluetooth tethering and the GPS signal receiver.

The first electronic device 20 is very small and has a sleek design that enables it to fit to the periphery of any and every personal item or possession. For example, the first electronic device 20 may be a battery operated and is configured to attach to keys, purse suit case etc.

The first electronic device 20 also comprises an alarm system 22, 23, 24. The alarm system 22, 23, 24 sounds an alarm using an audible tone played from a sound box 24 when one or more tagged possessions are removed from the proximity of the portable electronic device 10 which is in wireless connection with the first electronic device 20 attached to the personal item. The alarm is in the form of flashing lights flashed from a LED 23 or vibrating mechanism 22 with the audible tone played from the sound box 24. A pre-determined distance or geofence is present between the two electronic devices 10, 20 of the present disclosure by virtue of the Bluetooth tethering. The first electronic device 20 may be attached to the personal possessions like Keys, purse, suit case, etc.

In an embodiment, the mobile application 15 to be used for managing one first electronic device 20 shall be executed onto two portable smart devices 10, such as an Apple iWatch or iPhone.

In another embodiment, multiple first electronic devices 20 may be linked to one portable electronic devices 10. An application running in the portable electronic device is capable of displaying the relative positions of the multiple first electronic devices in a contour map. In a further example embodiment, the different sound alarms are generated for different electronic devices located at different positions.

The tracking system is built around the Bluetooth LTE Chip which has both Bluetooth and GPS capabilities. It is activated and governed by the mobile application running on the smart phone or PDA 10. The first electronic device 20 has a switch 25 which can be switched on and off button to push to tether the two devices 10, 20 via Bluetooth or to pull off the tethering between the devices 10, 20.

In the preferred embodiment of the disclosure when a personal possession or item tagged with the first electronic device 20 moves out the geofence, an alarm 22, 23, 24 is activated in the first electronic device 20 and a wireless signal is sent by the GPS signal transmitter 21 to the GPS signal receiver 14 activated by the mobile application running on the portable electronic device 10. The alarm 22, 23, 24 notifies the position and the wireless signal provides the location of the lost or left personal possession or item which encapsulates the first electronic device 20.

In an example embodiment, the portable electronic device 10 and the first electronic device 20 may include a gyro to determine to position of the first electronic device 20 with respect to portable electronic device 10. Further, the devices may use deduced reckoning methods to supplement the positional and directional information about the first electronic device 20 with respect to the portable electronic device 10.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present disclosure have been described above with regard to specific embodiments. These benefits and advantages, and any elements or limitations that may cause them to occur or to become more pronounced are not to be construed as critical, required, or essential features of any or all of the embodiments.

While the present disclosure has been described with reference to particular embodiments, it should be understood that the embodiments are illustrative and that the scope of the disclosure is not limited to these embodiments. Many variations, modifications, additions and improvements to the embodiments described above are possible. It is contemplated that these variations, modifications, additions and improvements fall within the scope of the disclosure.

What is claimed is:

1. A system for preventing loss of items, the system comprising:
a portable electronic device including a processor and a memory, the memory having computer-executable instructions stored therein that, when executed by the processor, causes the portable electronic device to generate a short range radio frequency communication signal; and
a first electronic device configured to communicate with the portable electronic device via the short-range radio frequency communication signal and generate different sound alarms based on a position of the first electronic device relative to the portable electronic device.

2. The system for preventing loss of items according to claim 1, wherein the short range radio frequency communication signal is a Bluetooth LE signal.

3. The system for preventing loss of items according to claim 1, wherein the portable electronic device is a smartphone or a tablet.

4. The system for preventing loss of items according to claim 1, wherein the first electronic device comprises an alarm system and a GPS signal transmitter.

5. The system for preventing loss of items according to claim 1, wherein the first electronic device is configured to wirelessly communicate with the portable electronic device using the short range radio frequency communication signal to a pre-determined range.

6. The system for preventing loss of items according to claim 1, wherein the items are selected from the group comprising a key chain, button, clip, wristband, watch, and briefcase.

7. The system for preventing loss of items according to claim 1, wherein the first electronic device is configured to operably adapt to the items.

8. The system for preventing loss of items according to claim 1, wherein the portable electronic device includes a mobile device.

9. The system for preventing loss of items according to claim 1, wherein the portable electronic device is configured to be searched by the first electronic device and vice-versa.

10. The system for preventing loss of items according to claim 3, wherein the portable electronic device comprises a display and a GPS signal receiver.

11. The system for preventing loss of items according to claim 3, wherein the portable electronic device is configured to automatically generate the short-range radio frequency communication signal in response to a user access to a display of the smartphone or the tablet.

12. The system for preventing loss of items according to claim 4, wherein an alarm raised by the alarm system includes a plurality of flashing lights or a vibration along with an audible tone.

13. The system for preventing loss of items according to claim 12, wherein the alarm is activated when the first electronic device and the portable electronic device move out of a geofence.

14. The system for preventing loss of items according to claim 13, wherein the first electronic device is configured to send out a wireless signal via the GPS signal transmitter when first electronic device moves out of the geofence.

15. The system for preventing loss of items according to claim 14, wherein the wireless signal is received by the portable electronic device using a GPS signal receiver to determine a location of the item.

16. The system for preventing loss of items according to claim 14, wherein the items are the items of personal use.

17. A system for preventing loss of items, the system comprising:
a portable electronic device including a processor and a memory, the memory having computer-executable instructions stored therein that, when executed by the processor, causes the portable electronic device to generate a short range radio frequency communication signal; and
a first electronic device including an alarm and a GPS signal transmitter, the first electronic device being configured to,
communicate with the portable electronic device via the short-range radio frequency communication signal,
and generate different sound alarms based on a position of the first electronic device relative to the portable electronic device, and
determine a positional and directional information of the first electronic device with respect to the portable electronic device.

18. A system for preventing loss of items, the system comprising:
a portable electronic device including a processor and a memory, the memory having computer-executable instructions stored therein that, when executed by the processor, causes the portable electronic device to generate a short range radio frequency communication signal; and
a first electronic device including an alarm and a GPS signal transmitter, the first electronic device being configured to,
communicate with the portable electronic device via the short-range radio frequency communication signal, and generate different sound alarms based on a position of the first electronic device relative to the portable electronic device, and
determine a positional and directional information of the first electronic device with respect to the portable electronic device;
wherein,
the portable electronic device is configured to receive the positional and directional information from a plurality of the first electronic device and display relative positions of the plurality of the first electronic devices in a contour map.
